(19) United States
(12) Patent Application Publication
(10) Pub. No.: US 2017/0161703 A1
(43) Pub. Date: Jun. 8, 2017

(54) SMART CART FOR SELF-CHECKOUT OF RETAIL MERCHANDISE

(71) Applicant: Wal-Mart Stores, Inc., Bentonville, AR (US)

(72) Inventor: Sagar N. Dodia, Newark, CA (US)

(21) Appl. No.: 15/356,908

(22) Filed: Nov. 21, 2016

Related U.S. Application Data
(60) Provisional application No. 62/262,825, filed on Dec. 3, 2015.
(60) Provisional application No. 62/405,307, filed on Oct. 7, 2016.

(51) Int. Cl. G06Q 20/18; G06K 7/14; G06K 19/06; G07G 1/00

(52) U.S. Cl. CPC G06Q 20/18; G07G 1/0072; G06K 7/1413; G06K 19/06028

(57) ABSTRACT

A self-checkout cart is provided, including a cart body, the cart body having an interior region, an access element located on the cart body, a first sensor located external to the interior region of the cart body, the first sensor configured to obtain information about an item to be placed within the interior region of the cart body, and a second sensor located within the interior region of the cart body, the second sensor configured to verify the information about the item obtained from the first sensor. Furthermore, an associated method is also provided.

### RELATED APPLICATIONS

This invention claims priority to U.S. provisional patent application Ser. No. 62/262,825, filed Dec. 3, 2015, entitled “Smart Cart for Self-Checkout of Retail Merchandise” and U.S. provisional patent application Ser. No. 62/405,307, filed Oct. 7, 2016, entitled “Smart Cart for Self-Checkout of Retail Merchandise”, the entireties of which are included herein by reference.

### FIELD OF TECHNOLOGY

The following relates to a self-checkout cart, and more specifically to embodiments of a smart cart for self-checkout of retail merchandise, and methods thereof

### BACKGROUND

Traditionally, customers must stand in lines to checkout retail merchandise, which requires a store cashier to process the transaction for the retail merchandise. Some retailers offer self-checkout lanes, but customers must still stand in a line and wait for other customers ahead of them in line. Because only a finite number of checkout lanes may be available, lines can quickly grow, frustrating customers. Moreover, in both traditional and self-checkout lanes, the customer must remove the retail merchandise from the customer's shopping cart for scanning, only to reload the shopping cart with the retail merchandise.

Thus, a need exists for an apparatus and method for a smart, self-checkout cart that allows a customer to checkout retail merchandise without having to wait in line.

### SUMMARY

A first aspect relates generally to a self-checkout cart comprising a cart body, the cart body having an interior region, an access element located on the cart body, a first sensor located external to the interior region of the cart body, the first sensor configured to obtain information about an item to be placed within the interior region of the cart body, and a second sensor located within the interior region of the cart body, the second sensor configured to verify the information about the item obtained from the first sensor.

A second aspect relates generally to a self-checkout cart comprising a cart body having a first end and a second end, the second end including a handle for maneuvering the cart body, wherein the cart body includes an interior region for storing a store item until a purchase is completed, a sliding door located on a top surface of the cart body between the first end and the second end, a first scanner located external to the interior region and positioned proximate the second end of the cart body, the first scanner scanning the store item for identifying information about the store item, wherein, in response to the store item being scanned by the first scanner, the sliding door opens so that the store item is placeable within the interior region, a second scanner located within the interior region of the cart body, the second scanner verifying that the store item scanned by the second scanner is a same item scanned by the first scanner, and confirming that no additional store items that were not scanned by the first scanner were placed within the interior region of the cart body, and a payment processing device operably coupled to the cart body for completing the purchase of the store item placed within the interior region of the cart body.

A third aspect relates generally to a method of self-checkout comprising receiving, by a processor of a computing system, information about a store item from a first sensor operably coupled to the computing system, the first sensor being located external to an interior region of a self-checkout cart, actuating, by the processor, an access element of the self-checkout cart, in response to the receiving the information from the first sensor, wherein a second sensor operably coupled to the computing system and located within the interior region detects and scans the store item entering the interior region, receiving, by the processor, information about the store item from the second sensor, verifying, by the processor, that the information received from the first sensor matches the information received from the second sensor and processing, by the processor, a payment for the store item located in the interior region to complete a transaction

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a perspective view of an embodiment of a smart, self-checkout cart;

FIG. 2 depicts a top view of an embodiment of the smart, self-checkout cart;

FIG. 3 depicts a cross-sectional view of an embodiment of the smart, self-checkout cart;

FIG. 4A depicts a perspective view of an embodiment of the smart, self-checkout cart, wherein an interior region is accessible;

FIG. 4B depicts a cross-sectional view of an embodiment of the smart, self-checkout cart, wherein the interior region is accessible;

FIG. 5 depicts a cross-sectional view of an embodiment of the smart, self-checkout cart, wherein the interior region is not accessible, and contains a product;

FIG. 6 depicts a block diagram of an embodiment of a smart cart self-checkout system;

FIG. 7 depicts a flow chart of an embodiment of a self-checkout method; and

FIG. 8 illustrates a block diagram of a computer system for the smart cart self-checkout system of FIGS. 1-6, capable of implementing methods for self-checkout of FIG. 7, in accordance with embodiments of the present invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

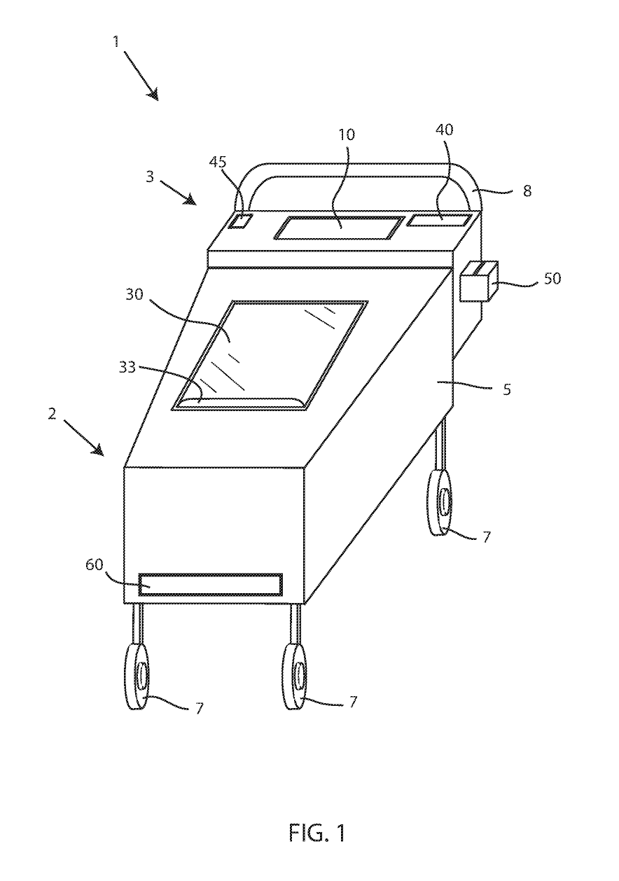

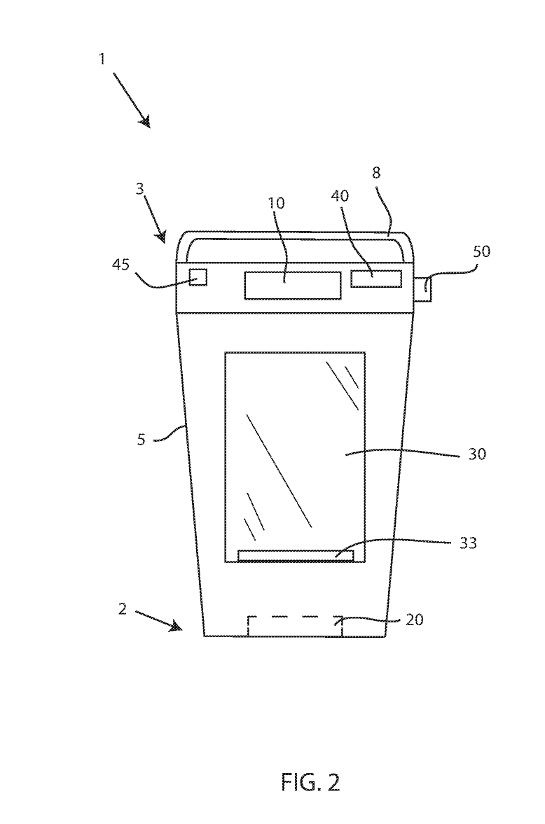

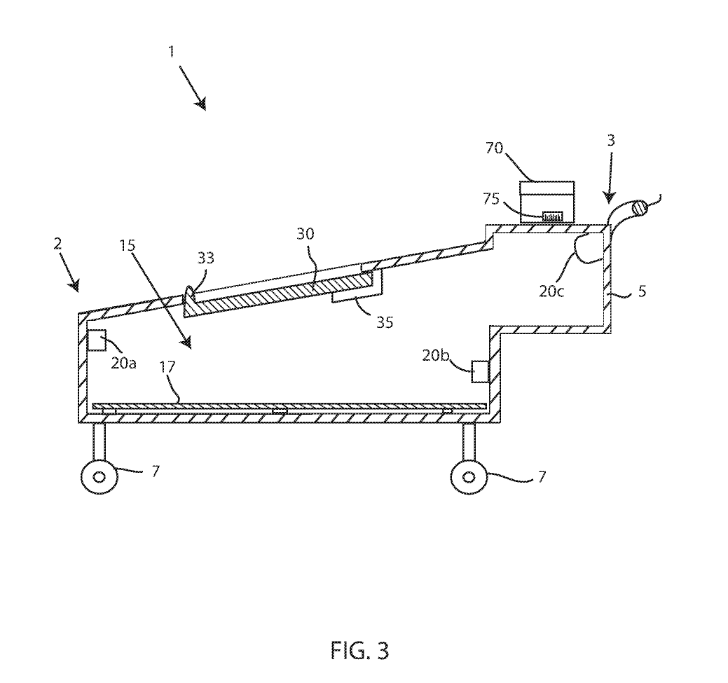

Referring to the drawings, FIGS. 1-3 depict an embodiment of a smart cart 1. Embodiments of smart cart 1 may be a shopping cart, a cart, a merchandise cart, a carriage, a container, a retail cart, a grocery cart, a supermarket cart, a buggy, a basket, a wagon, a self-checkout cart, a smart cart, an internet connected shopping cart, a computerized cart, a cart having a computer, a smart shopping cart, and the like. Embodiments of the smart cart 1 may include a computing system that may connect to, communicate with, and/or control various input and output devices over a network or wired connection, as described in greater detail infra. The smart cart 1 may be mobile, for example, may include at least one wheel 7 for transporting, pushing, or otherwise moving the smart cart 1. Further, embodiments of the smart cart 1 may include a first end 2 and a second end 3, wherein a front of the smart cart 1 may be defined by the first end 2, and a rear end of the smart cart 1 may be defined by the second end 3. Embodiments of the smart cart 1 may include a handle 8 proximate the second end 3 of the smart cart 3 to drive, steer, or otherwise maneuver the smart cart 1 on a salesfloor.

The smart cart 1 may be operated or otherwise used by a user in a shopping environment, such as a mall, a grocery store, a retail store, a salesfloor, superstore, and the like, or any environment that may offer merchandise for sale. Merchandise may include any good offered for sale, such as a items, products, produce, electronics, foodstuffs, packages, bags, equipment, tools, gift cards, and the like, or any tangible object that is being offered for sale by a retailer or other seller. If the user would like to add an item(s), such as store product 70, to the smart cart 1, the user may first scan the store product(s) 70 with a first sensor 10 located external to the interior region 15, and in response, access may be provided to the interior region 15 of the smart cart 1. A second sensor 20, located within the interior region 15 may scan the store product(s) 70 placed within the interior region 15 to verify that the store product(s) 70 scanned by the first sensor 10 is/are indeed the store product(s) scanned by the first sensor 10. When the user is finished shopping, the user may pay for the store product(s) 70 located in the interior region 15 of the smart cart 1, by interfacing with a payment processing device 50 located on the smart cart 1. Once payment is processed, access to the interior region 15 may again be provided so that the user can remove the store product(s) 70 from the smart cart 1 and take the product(s) home. Accordingly, a transaction for one or more store products 70 may securely and efficiently occur without the customer needing to wait in a line, interact with a store cahier, and/or remove the products 70 to scan at a checkout. Because the second sensor 20 verifies the information gathered by the first sensor 20, theft of products or other unlawful activity relating to avoiding paying for each item may be prevented or at least hindered.

Moreover, embodiments of the smart cart 1 may include a cart body 5. Cart body 5 may be the body, frame, general structure, etc., of the smart cart 1. The cart body 5 may be defined by a plurality of walls that can define an interior region 15. Embodiments of the interior region 15 may be an internal cavity, an internal space, a carriage area, an internal region, an interior space, a loading area, an interior loading area, a holding area, an enclosed area, an accessibly secured area or region, a receiving area, a merchandise holding region, and the like. Embodiments of the smart cart 1, in particular, the interior region 15 may be enclosed, substantially enclosed, fully enclosed, temporarily enclosed, accessibly enclosed, accessibly secure, and/or otherwise covered to control or secure an access to the interior region 15. The interior region 15 may be enclosed or covered substantially by the cart body 5; however, a portion of the smart cart 1 may be accessibly enclosed/covered by an access element 30. Further, embodiments of the cart body 5 may be comprised of metal, such as aluminum, stainless steel, metal alloys, or a combination thereof, or may be comprised of a plastic, a composite, or combinations of metal, composite, and/or metal.

With continued reference to FIGS. 1-3, embodiments of the smart cart 1 may include a first sensor 10, an access element 30, a second sensor 20, and a payment processing device 50. Embodiments of the smart cart 1 may include a cart body 5, the cart body 5 having an interior region 15, an access element 30 located on the cart body 5, a first sensor 10 located external to the interior region 15 of the cart body 5, the first sensor 10 configured to obtain information about an item 70 to be placed within the interior region 15 of the cart body 5, and a second sensor 20 located within the interior region 15 of the cart body 5, the second sensor 20 configured to verify the information about the item 70 obtained from the first sensor 10. Further embodiments may include a self-checkout cart 1, which may include a cart body 5 having a first end 2 and a second end 3, the second end 3 including a handle 8 for maneuvering the cart body 5, wherein the cart body 5 includes an interior region 15 for storing a store item 70 until a purchase is completed, a sliding door 30 located on a top surface of the cart body 5 between the first end 2 and the second end 3, a first scanner 10 located external to the interior region 15 and positioned proximate the second end of the cart body 5, the first scanner 10 scanning the store item 70 for identifying information about the store item 70, wherein, in response to the store item 70 being scanned by the first scanner 10, the sliding door 30 opens so that the store item 70 is placeable within the interior region 15, a second scanner 20 located within the interior region 15 of the cart body 5, the second scanner 20 verifying that the store item 70 scanned by the second scanner 20 is a same item scanned by the first scanner 10, and confirming that no additional store items that were not scanned by the first scanner 10 were placed within the interior region 15 of the cart body 5, and a payment processing device 50 operably coupled to the cart body 5 for completing the purchase of the store item 70 placed within the interior region 15 of the cart body 5.

Embodiments of the smart cart 1 may include a first sensor 10. Embodiments of the first sensor 10 may be a sensor, a scanner, a camera, a RF transmitter/receiver, an infrared scanner, a barcode reader, a laser scanner, a camera based reader, a CCD reader, a LED scanner, and the like. Embodiments of the first sensor 10 may be operably coupled to the cart body 5 for scanning a store product 70. The first sensor 10 may be configured to scan a store product 70 before the product 70 may be placed within the interior region 15 of the cart 1. By scanning the product 70, either as a whole, a portion or portions of the product 70, or by scanning a unique identifier 75 of the product 70 (i.e. scanning a barcode, UPC label, QR code, or other unique identifier of the product), information may be obtained regarding the product 70. The information may be general information about the product or similar products and/or identifying information about the product 70 which can be verified by a second scanning from the second sensor 20 within the interior region 15 of the cart 1. Information about the product 70 that may be obtained by the first sensor 10 may include price, price per pound, price per unit, weight, volume, model number, manufacturer information, size, dimensions, color, texture, pattern of packaging, nature of product (produce, tool, blanket, etc.), a retail store department associated with the product 70 scanned, a unique identifier, related or similar products, product reviews, and the like. Some of the information may be obtained directly from a unique identifier of the product 70, or a scan of the product 70. Other information may be obtained by scanning the product 70 with the first sensor 10 due to a network connection of an onboard computer communicatively coupled to the first sensor 10, which can access product information database(s) over a network to retrieve such information.

The information received from scanning the product 70 (e.g. swiping the product 70 over the first sensor 10 located on the cart body 5, or positioning the product 70 proximate the first sensor 10) may be presented to the user by a graphical user interface (GUI) 40. The GUI 40 may be a display, a touchscreen, a computer screen, a terminal, an interactive display, and the like, which may display information regarding the scanned product 70. Embodiments of the GUI 40 may display the price of the product 70 just scanned by the first sensor 10, and may also display the total balance of the products, such as product 70, placed within the interior region of the cart 1. The GUI 40 may also be searchable by the user to browse the various types of information regarding scanned products, or to retrieve further information about similar or related products. Embodiments of the GUI 40 may also allow a user to “log-in” to the smart cart 1, so that the smart cart 1 may receive or otherwise have knowledge of user preferences, user saved payment instruments (i.e. credit card, debit cards, e-gift cards, etc.), saved coupons, frequently purchased items. For instance, the user may enter a username and password into the GUI 40, which is operably connected to the onboard computer. In other embodiments, the smart cart 1 may access or communicate with a mobile device of the user, which may have user-related information stored thereon, or servers servicing relevant mobile applications running on the user's mobile device. In instances where a user is linked to the smart cart 1 (e.g. logged in), the smart cart 1 may authenticate the user, prior to retrieving or displaying any user-related information. In at least one embodiment, the smart cart 1 may not initiate system components until the smart cart 1 authenticates the user. Embodiments of the smart cart 1 may include a biometric identifier 45 to authenticate a user. Embodiments of a biometric identifier may include a fingerprint scanner, a retina scanner, a facial recognition camera, a voice signature detector, or similar device that can authenticate a user using a biometric of the user. In some embodiments, the biometric identifier 45 may be a button (physical or touchscreen) that sends a request to the user's mobile device to authenticate the user. For instance, activating the biometric identifier 45 may send a request to a user's mobile phone to prompt the user to authenticate the user by pressing the user's fingerprint on a fingerprint or other biometric scanner that is a hardware component of the user's mobile device.

In an exemplary embodiment, the first sensor 10 may be mounted to, embedded with, or placed flush or substantially flush with a top surface of the cart body 5. The first sensor 10 may be a flat surface for scanning a store product 70. Moreover, embodiments of the first sensor 10 may be disposed proximate or otherwise near the second end 3 of the cart body 5. For instance, the first sensor 10 may be placed proximate or otherwise near the rear end 3 of the cart 1, which may be close to the handle 8. In this embodiment, the first sensor 10 may be close to where the user may be standing while maneuvering the cart 1. The user may simultaneously push the cart 1 into a position or drive the cart 1 and grab a store item 70 for the first sensor 10 to scan. In other embodiments, the first sensor 10 may be located proximate the first end 2 or front edge of the cart 1. In further embodiments, the first sensor 10 may be positioned on a side of the cart 100, wherein a laser or other detection media projects outward so that a user may hold the item 70 proximate the sensor 10. In yet another embodiment, the cart 1 may include more than one first sensor 10 so that the user may be within arm's reach of a sensor 10 wherever the user stands in relation to the cart 1. In embodiments with multiple sensors for initially scanning a product, such as first sensor 10, the sensors may all communicate to the onboard computer. Embodiments of the GUI 40 and the biometric identifier 45 may be disposed proximate or otherwise near the first sensor 10. For example, the GUI 40 and the biometric identifier 45 may be located on a top surface of the cart body 5, proximate the second end 3 of the cart 1.

Referring still to FIGS. 1-3, embodiments of the smart cart 1 may include an access element 30. Embodiments of the access element 30 may be a door, a glass door, a transparent door, a security door, a transparent security door, a cover, a slidable cover, a slidable door, a sliding door, a pivotable door, a hinged door, an access control element, a sliding panel, a glass panel, an access panel, an access door, and the like. Embodiments of the access element 30 may be transparent, which may allow a user to view inside the interior region 15 of the cart 1 while the access element 30 is in a closed position, as shown in FIGS. 1-3. Embodiments of the access element 30 may be a flat or substantially flat component, having a thickness, and be comprised of glass, plastic, acrylic, acrylic glass, such as an acrylic sheet, or any rigid material or combination of materials that result in a transparent access element or cover.

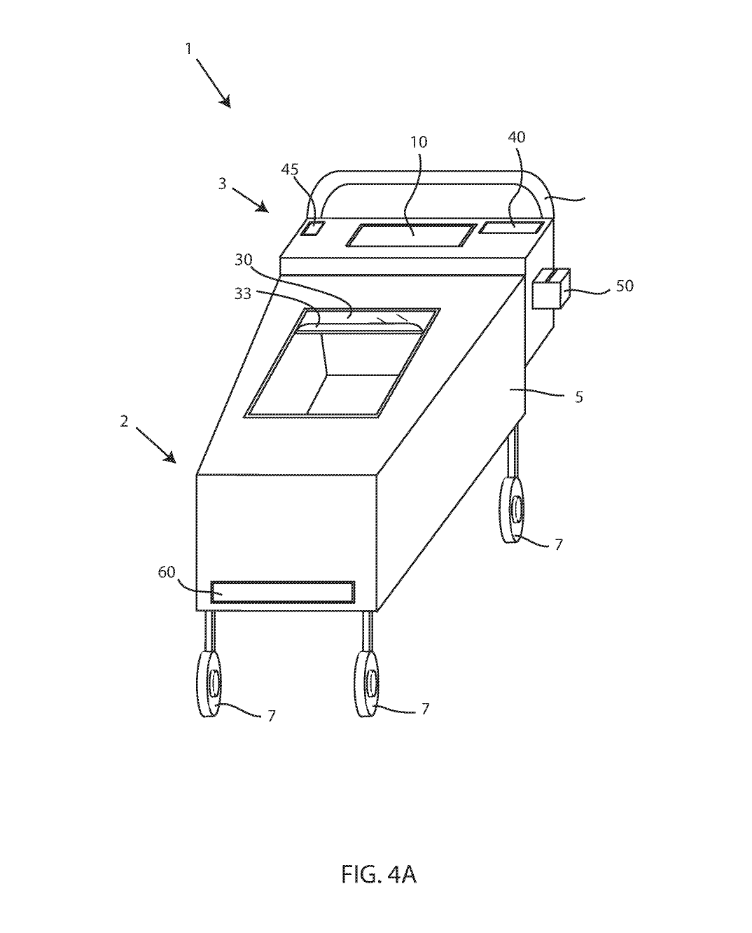

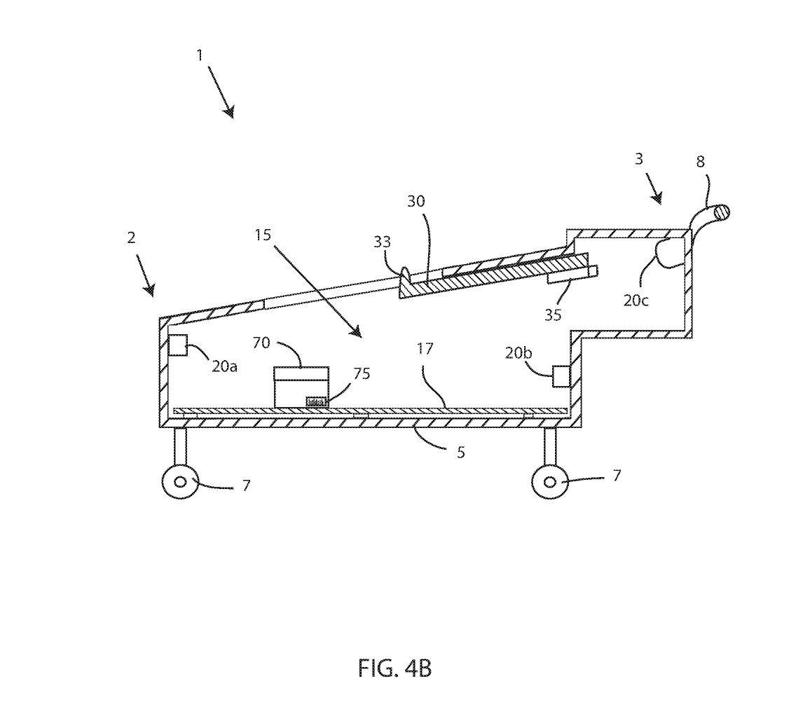

As depicted by FIGS. 4A and 4B, in response to the scanning of a product 70, by the first sensor 10, the access element 30 may be opened to provide access to the interior region 15 of the cart 1. For example, if a user intends to purchase an item, the item, such as product 70, may be first scanned or otherwise captured by the first sensor 10, which may then send a signal or command to open the access element 30 so that the user may place the item within the interior region 15. In an exemplary embodiment, the access element 30 may slide in a direction towards the second end 3 of the cart 1 in response to an actuation signal, wherein the access element 30 slides beneath a portion of the cart body 1, within the interior region 15. In other embodiments, the access element 30 may slide in a direction towards the first end 2 of the cart 1, or may slide in either direction transverse to the cart body 1. A slide action or movement of the access element 30 may be accomplished by known means, such as rails, tracks, rollers, and the like. In even further embodiments, the access element 30 may pivot or hinge inwardly into the interior region 15, or may pivot or hinge upwardly from the cart body 5, in response to an actuation signal. A pivoting or hinging action or movement of the access element 30 may be accomplished by known means, such as a hinge or a plurality of hinges. The sliding, pivoting, or general displacement of the access element 30 may be permitted by actuated an actuator 35, position proximate the access element 30. The actuator 35 may be positioned within the interior region 15 of the cart 1, and may communicate with the onboard computing system, such that in response to the scanning of a first product 10, an actuating signal is sent to the actuator 35 to actuate the access element 30. The actuator 35 may comprise various embodiments of locking devices, locking means, switches, levers, motors, and the like, that when actuated by the actuator 35 may release or drive the access element 30 in a desired direction to provide access or otherwise expose the interior region 15 of the cart 1. Because the access element 30 may be opened and closed, access to the interior region 15 of the cart 1 may be controlled.

While the access element 30 is in the open position, a user may place or otherwise insert one or more scanned products 70 into the interior region 15 of the cart 1. The products 70 placed within the cart 1 may be scanned by a second sensor 20. Embodiments of the second sensor 20 may disposed within the interior region 15 of the cart 1, such that the second sensor 20 is internal to the interior region 15. Embodiments of the second sensor 20 may be a plurality of sensors, such as sensor 20a, 20b, 20c. Embodiments of the second sensor 20 may be a sensor, a scanner, a camera, a RF transmitter/receiver, an infrared scanner, a barcode reader, a laser scanner, a camera based reader, a CCD reader, a LED scanner, and the like. The second sensor 20a, 20b, 20c may be positioned in various positions within the interior region 15 of the cart 1. In an exemplary embodiments, the second sensor(s) 20a, 20b, 20c may be operably coupled to or mounted to an inner surface or inner wall(s) of the cart body 5. The sensors 20a, 20b, 20c may also face each other or be positioned to maximize a cumulative viewing angle or window to the products 70 placed inside the interior region 15 of the cart 1. For instance, in one embodiment, sensor 20a may be placed near the opening to the interior region 15m sensor 20b may be placed at or near a bottom surface of the interior region 15, and sensor 20c may be placed in a corner, proximate a top or upper area of the interior region 15. Various placements of more than one sensor 20 may be utilized to capture, scan, or otherwise obtain necessary information/data from the products 70 placed within the interior region 15.

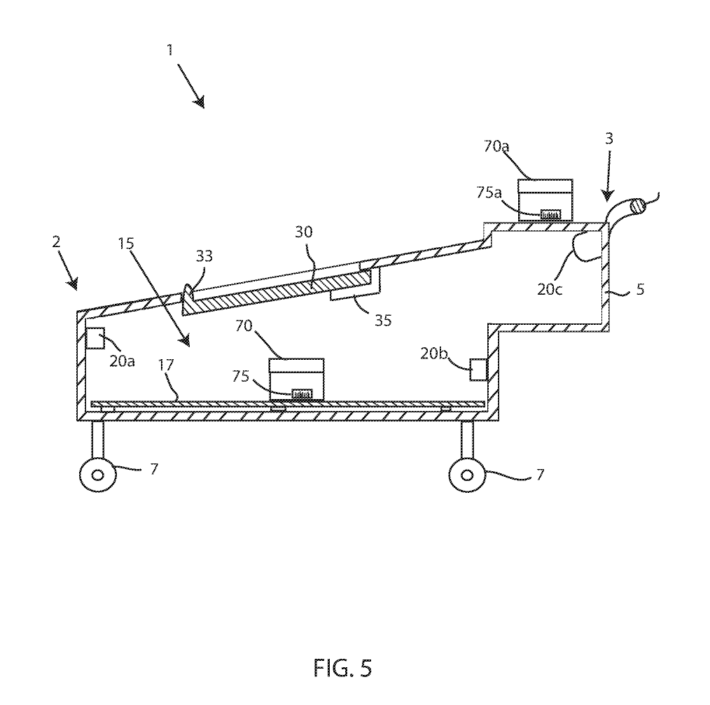

Moreover, the second sensor 20 may be configured to verify the information obtained from the first sensor 10. For example, the second sensor 20 may scan, capture, or otherwise analyze the product 70 now located in the interior region 15 to verify that the product 70 now located in the interior region 15 is the same product previously scanned by the first sensor 10. The scanning by the second sensor 20 may be performed automatically as the product 70 is entering the opening of the interior region 15, automatically after the product 70 has been placed therein through detection by the sensors 20a, 20b, 20c, or in response to the user, through interaction with the GUI 40, indicating or confirming that one or more products 70 have been scanned by the first sensor 10, or a combination thereof. In an exemplary embodiment, verification may be accomplished by confirming that one, some, or all of the following identifying information (where applicable or available) corresponds to the identifying information obtained from the first sensor 10: price, price per pound, price per unit, weight, volume, model number, manufacturer information, size, dimensions, color, texture, pattern of packaging, nature of product (produce, tool, blanket, etc.), a retail store department associated with the product 70 scanned, and a unique identifier. If the second sensor 20 cannot verify the first sensor 10, then the access element 30 may remain open, and error messages may be sent to the user via the GUI display 40, wherein the smart cart 1 may no longer accept new products 70. If the second sensor 20 can verify the first sensor 10, then the access element 30 be returned (e.g. via an actuation signal) to a closed position, wherein the product 70 is securely located within the interior region 15 of the cart 1, and the user may continue shopping for additional items 70a having an identifier 75a; this position is depicted by FIG. 5. Further, the GUI 40 may update a price total when the access element 30 is returned to a closed position.

In some embodiments, the smart cart 1 may include a weighing device 17. Embodiments of the weighing device 17 may be a scale or other platform that can precision measure a weight of one or more objects. Here, the weighing device 17 may obtain weight information of each product 70 as it is added, as well as keep track of a cumulative weight of all of the products 70, which may be then be used for further confirmation of the information obtained by the second sensor 20. In an exemplary embodiment, a floor or bottom surface of the interior region 15 may be scale, or comprised of the weighing device 17. In other embodiments, the weighing device 17 may be positioned slightly above the floor of the interior region 15.

Referring back to FIG. 1, embodiments of the smart cart 1 may include a payment processing device 50. Embodiments of the payment processing device 50 may be a payment terminal, a credit card payment processor a chip reader, a chip card reader, a magnetic stripe card reader, a point of sale terminal, and the like. Embodiments of the payment processing device 50 may facilitate a transaction between the user and the retailer to checkout for the product(s) 70 located within the interior region 15 of the cart 1. Embodiments of the payment processing device 50 may be operably coupled to the cart body 5. In an exemplary embodiment, the payment processing device 50 may be operably coupled or mounted to the cart body 5 proximate the second end 3 of the cart 1. When the user uses the payment processing device 50 to purchase the items in the cart 1, the access element 30 may be returned to an open position, allowing access to the interior region 15 of the cart 1. The user may then remove the purchased items from the cart 1. In some embodiments, the smart cart 1 may include an indicator 60, which may indicate a payment status of a smart cart 1. In one example, if no user is using the cart 1, or no user is associated or linked with the cart 1, the indicator 60 may indicate or otherwise display to other customers and store representatives that the cart 1 is available for use. Thus, the indicator 60 may read “AVAILABLE.” In another example, if a user is using the cart 1, and linked to the cart 1, the indicator 60 may indicate or otherwise display to other customers or store representatives that the cart 1 is in use. Thus, the indicator 60 may read, “IN USE.” In another example, if a user has paid for the merchandise in the cart 1, and is headed for the parking lot, the indicator 60 may indicate or otherwise display to other customers or store representatives that the cart's contents have been paid for. Thus, the indicator 60 may read, “PAID.”

Other security features may be employed with the smart cart 1. For example, the smart cart 1 may utilize geofencing technology to allow a user with “IN USE” status to browse around or near the store, and even take the smart cart 1 to the parking lot, so the user may pay for the goods using the payment processing device 50 next to the user's car, making unloading easier for the user. But if a user attempts to take the cart 1 beyond the parking lot, a mechanical lock may be actuated to prevent further movement, once outside the geofence.

Further components may be implemented with embodiments of the smart cart 1. For example, embodiments of the smart cart 1 may have output a location signal, wherein a user may press a button, potentially through interaction with the GUI 40, to call for help from a store representative. The smart cart 1 may broadcast the location signal, which may contain information such as aisle location within the store, and that can be received by a handheld terminal of the store representative. Additionally, embodiments of the smart cart 1 may include a produce scale or weighing device coupled to the cart body 5, wherein the scale includes a sensor, such as a first sensor that can communicate results to the onboard computer. For example, a user may be able weigh loose produce placed into a bag, and because the scale also scans the produce, the access element 30 may be opened for placement within the interior region 15 of the cart 1. Further, the GUI 40 may be loaded with a map of the store, such that a user may interact with the GUI 40 to navigate the store. For instance, a user may search for a particular good or product via the GUI 40, and then receive detailed directions on how to locate a particular product from a current position with the store.

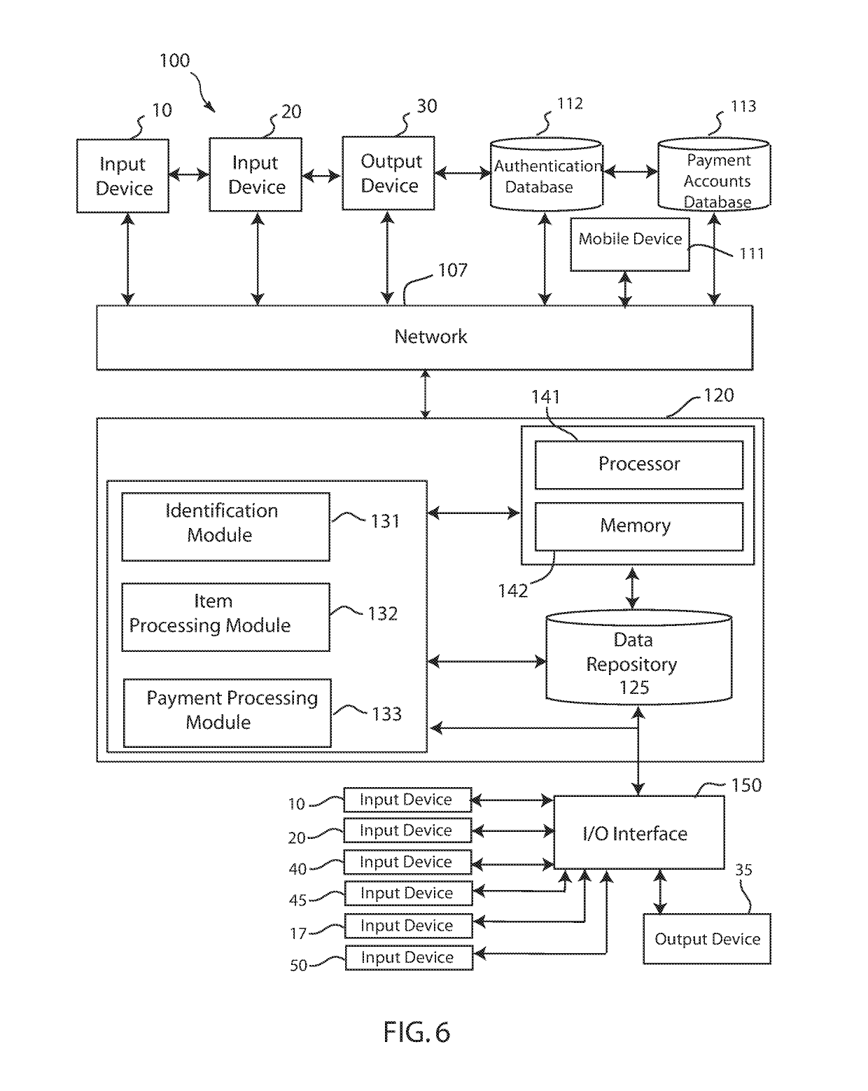

Referring still to the drawings, FIG. 6 depicts a block diagram of a smart cart self-checkout system 100, in accordance with embodiments of the present invention. Embodiments of the smart cart self-checkout system 100 may comprise one or more input devices 10, 20, 20a, 20b, 20c, 40, 45, 17, 50 and out device 35 communicatively coupled to a computing system 120 via an I/O interface 150 and/or over a network 107. For instance, some or all of the input devices 10, 20, 20a, 20b, 20c, 40, 45, 17, 50 and output device 35 may be connected via an I/O interface 150 to computer system 120. Embodiments of the computing system 120 may be an onboard computer of the smart cart 1, or may be a computing system coupled to the smart cart 1. The number of input devices and output devices connecting to computer system 120 may be connected via data bus lines and/or over network 107 may vary from embodiment to embodiment, depending on the number of input and output devices present in the smart cart self-checkout system 100.

As shown in FIG. 6, a number of sensors 10, 20, 20a, 20b, 20c, 40, 45, 17, 50 may transmit data about the user operating the smart cart 1 or a product 70 received from the input devices 10, 20, 20a, 20b, 20c, 40, 45, 17, 50 by connecting to computing system 120 via the data bus lines 155 to an I/O interface 150. An I/O interface 150 may refer to any communication process performed between the computer system 120 and the environment outside of the computer system 120, for example, the input devices 10, 20, 20a, 20b, 20c, 40, 45, 17, 50. Input to the computing system 120 may refer to the signals or instructions sent to the computing system 120, for example the data collected by the first sensor 10, the second sensor 20, the GUI 40, the biometric identifier 45, the weighing device 17, and payment processing device 50, while output may refer to the signals sent out from the computer system 120, such as an actuation signal to the actuator 35.

Some or all of the input devices 10, 20, 20a, 20b, 20c, 40, 45, 17, 50 may transmit data about the user or product 70 by connecting to computing system 120 over the network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120, and input devices 10, 20, 20a, 20b, 20c, 40, 45, 17, 50, a connection to one or more network accessible knowledge bases containing information of one or more users, network repositories or other systems connected to the network 107 that may be considered nodes of the network 107. In some embodiments, where the computing system 120 or network repositories allocate resources to be used by the other nodes of the network 107, the computer system 120 and network repository may be referred to as servers.

The network repository may be a data collection area on the network 107 which may back up and save all the data transmitted back and forth between the nodes of the network 107. For example, the network repository may be a data center saving and cataloging user's transactions and purchase history and preferences to generate both historical and predictive reports regarding a particular user. In some embodiments, a data collection center housing the network repository may include an analytic module capable of analyzing each piece of data being stored by the network repository. Further, the computer system 120 may be integrated with or as a part of the data collection center housing the network repository. In some alternative embodiments, the network repository may be a local repository that is connected to the computer system 120.

Referring still to FIG. 6, embodiments of the computing system 120 may receive the product 70 or user data/information from one or more input devices 10, 20, 20a, 20b, 20c, 40, 45, 17, 50 which may be positioned on the smart cart 1, or within an interior region 15 of the smart cart 1. The input devices 10, 20, 20a, 20b, 20c, 40, 45, 17, 50 may be a sensor, an input device, or an input mechanism.

Embodiments of the computer system 120 may be equipped with a memory device 142 which may store the various user information, transactions, product information, mobile payment account information, and the like, and a processor 141 for implementing the tasks associated with the smart cart self-checkout system 100.

Furthermore, embodiments of the one or more input devices 10, 20, 20a, 20b, 20c, 40, 45, 17, 50 may be in communication with each other. The input devices 10, 20, 20a, 20b, 20c, 40, 45, 17, 50 may interact with each other for collecting comprehensive, accurate, timely, and organized data, and sending to computing system 120. Any sensor may communicate with the other sensors. The interactive communication between the input devices 10, 20, 20a, 20b, 20c, 40, 45, 17, 50 may modify, update, augment, bolster, confirm, reference, etc. data received and/or collected by the second sensor 20 to improve the accuracy and efficiency of the verification, by the second sensor 20, of the first sensor 10.

Embodiments of computer system 120 may include an identification module 131, an item processing module 132, and a payment processing module 133. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the identification module 131 may include one or more components of hardware and/or software program code for authenticating and/or identifying a user of the smart cart 1. For example, the identification module 131 may obtain, retrieve, or receive identifying information from a user's mobile device 111, the GUI 40 and/or the biometric identifier 45. The identification module 131 may query one or more database(s) 112, such as an authentication database 112 to authenticate a user of a smart cart 1, or a user of a mobile device 111 that is attempting to pair with the smart cart 1. Embodiments of the authentication database 112 may be one or more databases, storage devices, repositories, and the like, that may store or otherwise contain information and/or data regarding personal account information of a user, such as name, account identifiers, passwords, pin numbers, address information, other personal identifying information and the like, that may be associated with a mobile application on the mobile device 111 of the user. The customer authentication database 112 may be accessed over network 107, and may be managed and/or controlled by a third party, or by a retailer associated with the mobile application on the user's mobile device 111. Embodiments of the identification module 131 may retrieve, receive, obtain, derive, etc. authenticating information from the customer authentication database 112. For instance, the identification module 131 may query the customer authentication database 112 to identify a user that has submitted identifying information via the GUO 40 or the biometric identifier, or has used a mobile device 111 to transmit a communication the smart cart 1 as part of a paring or linking process between the user and the smart cart 1. Once an identity is established by the identification module 131, the identification module 131 may request that the identity be confirmed by the user using one of the methods not used to initially establish identity. For instance, if the user entered a login and password into the GUI 40, the identification module 131 may request that the user submit a fingerprint via the biometric identifier 45 (or fingerprint sensor on the user's mobile device), or may request that the user enter a pin number in response to a request sent to the mobile device 111 from the identification module 131.

In addition, the identification module 131 may further use payment account information to authenticate the user. For example, the identification module 131 may query one or more databases, such as a payment accounts database 113 to further confirm or authenticate the user. Embodiments of the payment accounts database 113 may be one or more databases, storage devices, repositories, and the like, that may store or otherwise contain information and/or data regarding one or more payment instruments associated with the user and the user's mobile application on the mobile device 111. The payment accounts database 113 may also be accessed over network 107, and may be affiliated with, managed, and/or controlled by one or more financial institutions, issuers, authorizers, and the like. Embodiments of the identification module 131 may query the payment accounts database 113 to identify a user based on one or more payment instruments associated with the user. Payment instruments may be a bank account, a credit card account, a debit card, a checking account, an electronic gift card, and the like. Embodiments of the identification module 131 may retrieve or otherwise receive payment instrument information stored on the mobile device 111 or stored on a remote server servicing the mobile device 111, and may compare the information to authenticate the user.

Embodiments of the computing system 120 of the smart cart self-checkout system 100 may also include an item processing module 132. Embodiments of the item processing 132 may include one or more components of hardware and/or software program code for controlling access to the interior of the smart cart 1 to accept merchandise. For example, the item processing module 132 may receive a signal from the first sensor 10, which may contain identifying information of one or more products 70. In response to receiving the signal from the first sensor, the item processing module 132 may transmit an actuation signal to the actuator 35 associated with the access element 30 to release, drive, or otherwise displace the access element 30. The item processing module 132 may the receive a signal from the second sensor 20 which may include information/data regarding the products 70 now placed within the interior region 15 of the smart cart 1. Embodiments of the item processing module 132 may compare the information received from each sensor 10, 20 to verify that the product 70 scanned by with the first sensor 10 is the same product 70 now located within the interior region 15, as described supra. Additionally, the item processing module 132 may receive information from the weighing device 17 to enhance the accuracy of the verification. Embodiments of the item processing module 132 may determine whether the information received from the second sensor 20 corresponds or matches the information received from the first sensor 10. If the information is verified, then the item processing module 132 may transmit another actuation signal to the actuator 35 associated with the access element 30 to close off the interior region 15. If the information is not verified, then the item processing module 132 may transmit an error message to the GUI 40 of the smart cart 1. This process may be repeated until the user is finished shopping and wants to now checkout and pay for the items placed within the smart cart 1.

With continued reference to FIG. 6, embodiments of the computing system 120 of the smart cart self-checkout system 100 may include a payment processing module 134. Embodiments of the payment processing module 134 may include one or more components of hardware and/or software program code for facilitating a transaction for the products 70 placed within the smart cart 1 by the user for purchase. For instance, embodiments of the payment processing module 133 may receive payment information from the payment processing device 50, when the user uses physically interacts with the payment processing device 50. In response to receiving the payment information, the payment processing module 133 may transmit the payment information to another server or servers that facilitate monetary transaction. In other words, the payment processing module 133 may instruct a payment processing application operated on a different (or same) server that can effectuate a monetary transaction, as known to those skilled in the art. In alternative embodiments, the user may not need to physically interact with the payment processing device 50, but may rely on contactless payment methods, wherein a “digital wallet” application on the user's mobile device 111 may communicate with the payment processing module 133 (to receive the total bill, etc.) and complete the transaction. Further, embodiments of the payment processing module 133 may then display an indication of a paid status on the display 60.

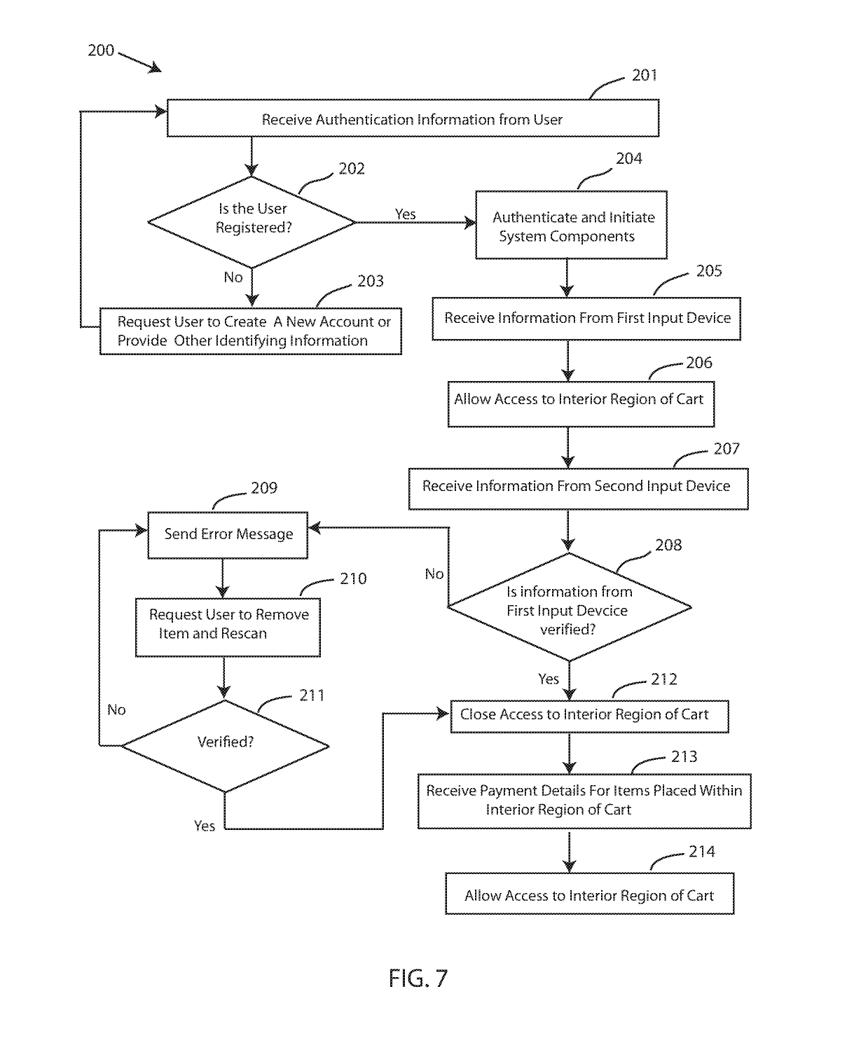

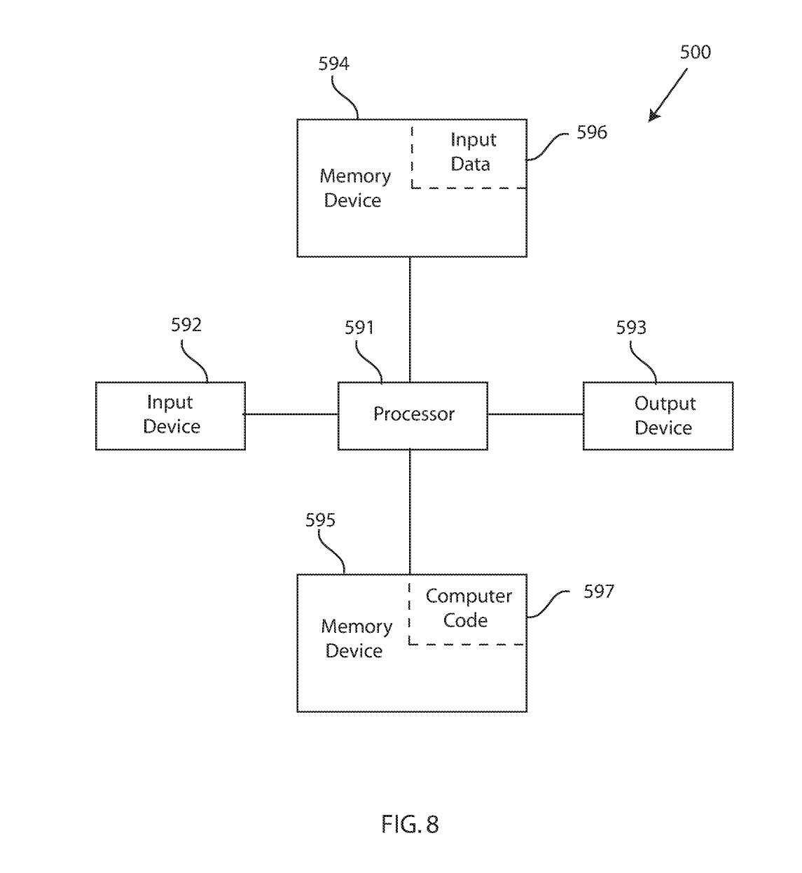

Referring now to FIG. 7, which depicts a flow chart of a method 200 for self-checkout, in accordance with embodiments of the present invention. One embodiment of a method 200 or algorithm that may be implemented for self-checkout using a smart cart 1 in accordance with the smart cart self-checkout system 100 described in FIGS. 1-6 using one or more computer systems as defined generically in FIG. 8 below, and more specifically by the specific embodiments of FIGS. 1-6.

Embodiments of the method 200 for self-checkout may begin at step 201 wherein authenticating or identifying information is received from the user. Step 202 determines whether the user is registered, or has an existing account that can be used to authenticate the user. If the user does not have a current account, step 203 sends a request to the user that the user create a new account that can be authenticated with one or more identifying information. After the user creates a new account, the method starts again at step 201. If the user does have an existing account that can be authenticated, then step 204 authenticates the user, so that the smart cart 1 may be paired with or linked with a user account. In some embodiments, the cart 1 may be used without authentication or linking a user account. In embodiments that require authentication of a user, system components may be in an off position, and then may be activated and/or initiated upon a successful authentication of a user. As the user is shopping, step 205 receives information about a product 70 from the first sensor 10. In response to receiving the information from the first sensor 10, step 206 allows access to the interior region 15 of the smart cart 1. In other words, the access element 30 is moved from a closed position to an open position. Step 207 receives information from a second sensor 207, based on the products 70 located within the cart 1. Step 208 determines whether the information received from the first input is verified by the second sensor 20. If not, then step 209 sends an error message to notify the user. Step 210 requests that the user remove the product 70 and rescan the product 70 with the first sensor 10. Step 211 once again determines whether the information received from the first input 10 is verified by the second input 20. Once verified, step 212 closes access to the interior region 15 of the cart 1. In other words, the access element 30 is moved from an open position to a closed position. Step 213 receives payment details to complete a purchase for goods located within the cart 1. Once payment is completed, step 214 opens access to the interior region 15 of the cart, by moving the access element 30 from a closed position to an open position.

FIG. 8 illustrates a block diagram of a computer system 500 that may be included in the system of FIGS. 1-6 and for implementing the methods of FIG. 7 in accordance with the embodiments of the present disclosure. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for self-checkout, in the manner prescribed by the embodiments of FIG. 7 using the refund processing system of FIGS. 1-6, wherein the instructions of the computer code 597 may be executed by processor 591 via memory device 595. The computer code 597 may include software or program instructions that may implement one or more algorithms for implementing the methods for self-checkout, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 8.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a device, a sensor, a mobile device, and the like. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 6.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to smart cart self-checkout systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to allow a self-checkout using a smart cart accordance with embodiments of the present invention. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for self-checkout using a smart cart. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for self-checkout.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A self-checkout cart comprising:
a cart body, the cart body having an interior region;
an access element located on the cart body;
a first sensor located external to the interior region of the cart body, the first sensor configured to obtain information about an item to be placed within the interior region of the cart body; and
a second sensor located within the interior region of the cart body, the second sensor configured to verify the information about the item obtained from the first sensor.

2. The self-checkout cart of claim 1, wherein the access element provides access to the interior region upon obtaining the information about the item, by the first sensor.

3. The self-checkout cart of claim 2, wherein a processor is operably coupled to the first sensor to control the access element.

4. The self-checkout cart of claim 1, further comprising a payment processing device coupled to the cart body for completing a purchase of the item placed within the interior region of the cart.

5. The self-checkout cart of claim 4, wherein the access element is opened upon completion of the purchase to allow the item to be removed from the interior region of the cart body.

6. The self-checkout cart of claim 1, wherein the information obtained by the first sensor of the item includes at least one of a price of the item, an image of the item, a bar code of the item, a weight and a size of the item, a unique identification of the item, a Universal Product Code, and a stock keeping unit.

7. The self-checkout cart of claim 1, further comprising a weighing device located within the interior region of the cart body.

8. A self-checkout cart comprising:
a cart body having a first end and a second end, the second end including a handle for maneuvering the cart body, wherein the cart body includes an interior region for storing a store item until a purchase is completed;
a sliding door located on a top surface of the cart body between the first end and the second end;
a first scanner located external to the interior region and positioned proximate the second end of the cart body, the first scanner scanning the store item for identifying information about the store item, wherein, in response to the store item being scanned by the first scanner, the sliding door opens so that the store item is placeable within the interior region;
a second scanner located within the interior region of the cart body, the second scanner verifying that the store item scanned by the second scanner is a same item scanned by the first scanner, and confirming that no additional store items that were not scanned by the first scanner were placed within the interior region of the cart body; and
a payment processing device operably coupled to the cart body for completing the purchase of the store item placed within the interior region of the cart body.

9. The self-checkout cart of claim 8, wherein the sliding door closes upon verifying, by the second scanner, and opens upon at least one of a completion of the purchase and an additional store item being scanned by the first scanner.

10. The self-checkout cart of claim 8, further comprising:
a graphical user interface positioned proximate the first scanner, the graphical user interface displaying at least one of a product information, a store information, a product location, and checkout instructions; and
an indicator display unit positioned at the first end of the cart body, the indicator display unit displaying a status associated with the self-checkout cart.

11. The self-checkout cart of claim 8, further comprising a signal transmitter to transmit a signal to a computing system of a store representative, wherein the signal is a location of the cart body.

12. The self-checkout cart of claim 8, further comprising a weighing device positioned external to the interior region for weighing the store item.

13. The self-checkout cart of claim 8, wherein a floor surface of the interior region of the cart body comprises a weighing platform to verify an aggregate weight of one or more store items placed within the interior region.

14. A method of self-checkout comprising:
receiving, by a processor of a computing system, information about a store item from a first sensor operably coupled to the computing system, the first sensor being located external to an interior region of a self-checkout cart;
actuating, by the processor, an access element of the self-checkout cart, in response to the receiving the information from the first sensor, wherein a second sensor operably coupled to the computing system and located within the interior region detects and scans the store item entering the interior region;
receiving, by the processor, information about the store item from the second sensor;
verifying, by the processor, that the information received from the first sensor matches the information received from the second sensor; and
processing, by the processor, a payment for the store item located in the interior region to complete a transaction.

15. The method of claim 14, further comprising: closing, by the processor, the access element after the verifying.

16. The method of claim 14, further comprising: opening, by the processor, the access element after processing the payment.

17. The method of claim 14, further comprising: displaying, by the processor, on a display unit located on the self-checkout cart, that the transaction is completed.

18. The method of claim 14, wherein the information obtained by the first sensor of the store item includes at least one of a price of the store item, an image of the store item, a bar code of the store item, a weight and a size of the store item, a unique identification of the store item, a Universal Product Code, and a stock keeping unit.

19. The method of claim 14, further comprising: obtaining, by the processor, an aggregate weight of one or more store items located within the interior region.

20. The method of claim 14, further comprising: transmitting, by the processor, a location signal of self-checkout cart.
